(19) United States
(12) Patent Application Publication
(10) Pub. No.: US 2022/0266480 A1
(43) Pub. Date: Aug. 25, 2022

(54) DEVICE FOR CONSOLIDATING A PART MADE OF COMPOSITE MATERIAL BY INDUCTION HEATING

(71) Applicant: Airbus Operations SAS, Toulouse (FR)

(72) Inventor: Florian CHOTARD, TOULOUSE (FR)

(21) Appl. No.: 17/674,948

(22) Filed: Feb. 18, 2022

(30) Foreign Application Priority Data
Feb. 22, 2021 (FR) 2101713

(51) Int. Cl. B29C 35/08; B29C 35/02; B29C 70/68

(52) U.S. Cl. CPC B29C 35/0805; B29C 35/0272; B29C 70/683; B29C 2035/0811; B29L 2031/3082

(57) ABSTRACT

A device for consolidating a fiber preform to obtain a panel made of composite material of large dimension, comprising an induction heating system configured to generate at least one electromagnetic field in a heating zone, at least one susceptor incorporated in a first die tool supporting the fiber preform and/or a cladding covering the fiber preform, each susceptor producing a uniform heating of the fiber preform when it is positioned in the electromagnetic field of the induction heating system, and a mechanism configured to induce a relative movement between the induction heating system and the first die tool so that all the fiber preform crosses the heating zone.

### CROSS-REFERENCES TO RELATED APPLICATIONS

This application claims the benefit of the French patent application No. 2101713 filed on Feb. 22, 2021, the entire disclosures of which are incorporated herein by way of reference.

### BACKGROUND OF THE INVENTION

The present invention relates to a device for consolidating a part made of composite material by induction heating.

According to one embodiment, a part made of composite material comprises reinforcing fibers embedded in a thermoplastic matrix. According to one procedure, fiber plies, pre-impregnated or not, are stacked on a support surface of a metal die tool to obtain a fiber preform. Next, this fiber preform is consolidated in order to obtain the part made of composite material. During this consolidation step, the preform is covered by a cladding comprising a forming plate and a bladder linked to the support surface via sealing elements positioned at the periphery of the fiber preform.

During this consolidation step, the metal die tool, the fiber preform, and the cladding are positioned in a chamber, such as an oven or an autoclave for example, then subjected to a pressure and temperature cycle. During this temperature cycle, the temperature rise and fall are very slow given the convective-conductive heating mode and the volume of the chamber, which induces long consolidation cycles.

This procedure is not fully satisfactory, notably in the case of parts of large dimensions, the necessary investments being relatively great for each installation, the latter having to be multiplied given the cycle time to increase production rates.

The present invention aims to remedy all or some of the drawbacks of the prior art.

### SUMMARY OF THE INVENTION

To this end, a subject of the invention is a device for consolidating a fiber preform to obtain a panel made of composite material having a first face, a second face opposite the first face, transverse sections linking the first and second faces, the panel extending in a longitudinal direction, the preform comprising a first end and a second end opposite the first end in the longitudinal direction, the consolidation device comprising a first die tool which has a support surface, in contact with the fiber preform, formed as the first face of the panel to be obtained, a cladding configured to cover the fiber preform and a heating system configured to heat the fiber preform.

According to the invention, the heating system is an induction heating system configured to generate at least one electromagnetic field in a heating zone. The heating zone covers a surface lower than a surface occupied by the fiber preform. In addition, the consolidation device comprises susceptors, incorporated in at least one out of the first die tool and the cladding, producing a heating when they are positioned in the electromagnetic field generated by the induction heating system. In addition, the consolidation device comprises a mechanism configured to induce a relative movement between the induction heating system and the first die tool supporting the fiber preform such that the fiber preform crosses the heating zone from its first end to its second end.

The induction consolidation device makes it possible to obtain a heating with a high thermal responsiveness and improve energy efficiency.

According to another feature, the cladding comprises a forming plate comprising a face oriented towards the fiber preform and formed as the second face of the panel to be obtained, at least one of the susceptors being incorporated in the forming plate.

According to another feature, the susceptors comprise a plurality of discontinuous conductive elements.

According to another feature, the induction heating system comprises a tunnel which has a constant flow cross-section, configured in such a way that there remains a small space all around a maximum cross-section of an assembly formed by the fiber preform, the first die tool and the cladding. This tunnel advantageously makes it possible to concentrate the electromagnetic field generated by the induction heating system and, thus, to improve the energy efficiency of the consolidation device.

According to another feature, the induction heating system comprises at least one solenoid having a winding section which follows the profile of the flow cross-section.

According to another feature, the induction heating system is fixed, and the consolidation device comprises a displacement mechanism configured to translate the first die tool with respect to the induction heating system in the longitudinal direction.

According to another feature, the induction heating system comprises rolling or sliding seats, the first die tool being in contact with the rolling or sliding seats. This makes it possible to promote the scrolling of the first die tool with respect to the induction heating system.

According to another feature, the consolidation device comprises at least one track upstream and/or downstream of the induction heating system, the first die tool being supported by the track.

According to another feature, the first die tool is produced in at least one material with low expansion coefficient.

According to another feature, the first die tool comprises a rigid supporting structure having a recess on a first face oriented towards the fiber preform and a mat configured to be housed in the recess and to which the fiber preform is affixed, at least one susceptor being incorporated in the mat.

### BRIEF DESCRIPTION OF THE DRAWINGS

Other features and advantages will emerge from the following description of the invention, a description given purely by way of example, in light of the attached drawings in which:

FIG. 1 is a side view of an aircraft,

FIG. 2 is a perspective schematic representation of a fuselage panel,

FIG. 3 is a perspective schematic representation of an induction heating system used to consolidate a fiber preform, in order to obtain the fuselage panel visible in FIG. 2, illustrating an embodiment of the invention,

FIG. 4 is a perspective view of the induction heating system visible in FIG. 3,

FIG. 5 is a top view of an induction heating system and of a fiber preform illustrating an embodiment of the invention,

FIG. 6 is a diagram illustrating several curves of temperatures as a function of time with different cross-sections of the fiber preform visible in FIG. 5 during a consolidation step,

FIG. 7 is a cross-section of an induction heating consolidation device and of a fiber preform illustrating a first embodiment, and

FIG. 8 is a cross-section of a die tool and of a fiber preform illustrating a second embodiment of the invention.

### DETAILED DESCRIPTION OF THE PREFERRED EMBODIMENTS

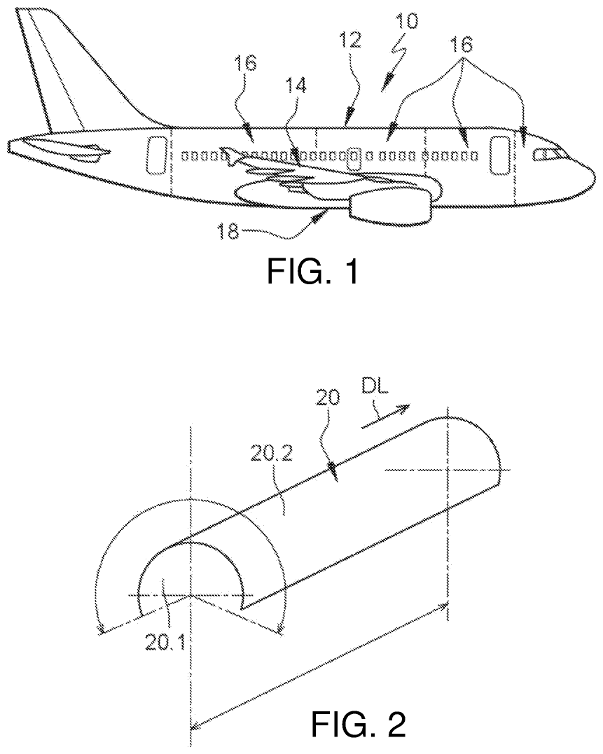

As illustrated in FIG. 1, an aircraft 10 comprises a fuselage 12 and wings 14 arranged on either side of the fuselage 12. This fuselage comprises several sections 16, a central wing box ensuring the link between the fuselage 12 and the wings 14 and a ventral beam 18, positioned in the lower part of the fuselage 12, ensuring structural continuity between the sections 16 of the fuselage arranged on either side of the central wing box.

According to one configuration, a section 16 of the fuselage 12 comprises an upper fuselage panel 20 visible in FIG. 2 and a lower fuselage panel. The upper fuselage panel 20 has a regular section in a longitudinal direction DL. As an example, an upper fuselage panel has a length of between 20 and 25 m, a diameter of 4 to 6 m and extends over an angular sector greater than 180°.

Regular section is understood to mean that the panel has a maximum section and that all the other sections of the panel fit within this maximum section. In the case of an upper fuselage panel 20, the latter has, in transverse planes (at right angles to the longitudinal direction DL), the same curvature but its sections may possibly not be constant and may possibly not extend over the same angular sector.

According to one embodiment, the upper fuselage panel 20 is made of composite material comprising reinforcing fibers, for example made of carbon, embedded in a resin matrix, for example thermoplastic.

According to one procedure, a method for manufacturing an upper fuselage panel 20 made of thermoplastic composite material comprises a step of obtaining of a fiber preform 22 and a consolidation step aiming to transform the fiber preform 22 into a rigid panel of composite material. The fiber preform 22 comprises a plurality of fiber plies stacked one on top of the other. A consolidation consists in applying a thermal cycle under pressure and/or in a vacuum, in order to achieve the melting of the polymer of the fiber preform 22 and to create inter-layer bonds between the different plies.

The invention is not limited to the upper fuselage panel 20. It can be used for any rigid panel made of composite material with a regular and elongate section, such as an L, C, U, H, I, Z or O section, for example.

Whatever the configuration, the panel 20 and the fiber preform 22 comprise a first face 20.1, 22.1, a second face 20.2, 22.2 opposite the first face 20.1, 22.1 and transverse sections linking the first and second faces 20.1, 22.1, 20.2, 22.2. The fiber preform 22 comprises a first end 21.1 and a second end 21.2 opposite the first end 21.1 in the longitudinal direction DL.

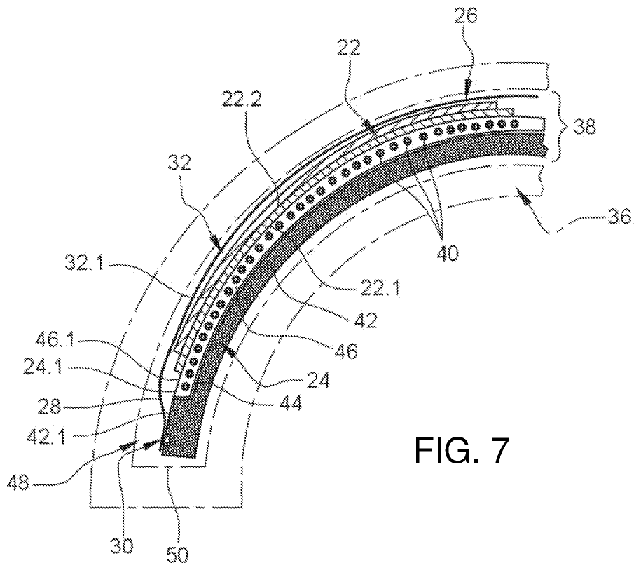

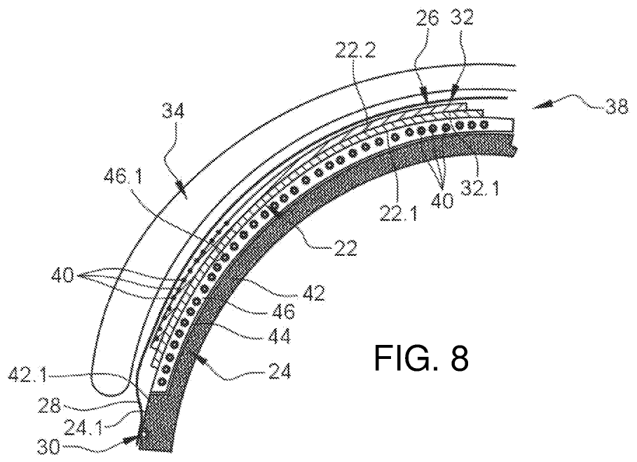

A consolidation device is used to transform the fiber preform 22 into a rigid panel 20. As illustrated in FIGS. 7 and 8, this device comprises a first die tool 24 which has a support surface 24.1, in contact with the first face 22.1 of the fiber preform 22, formed as the first face 20.1 of the panel 20 to be obtained. The device also comprises a cladding 26 configured to cover the fiber preform 22. Thus, the latter is inserted between the first die tool 24 and the cladding 26 during the transformation into a rigid panel.

This cladding comprises a bladder 28 linked to the support surface 24.1 via sealing elements 30 positioned at the periphery of the fiber preform 22. The periphery of the fiber preform 22 is a cold technical area, that is to say, unheated, which allows the use of sealing elements such as permanent seals, that is to say, not consumable seals. Generally, the cladding 26 also comprises a forming plate 32 inserted between the fiber preform 22 and the bladder 28. The forming plate 32 comprises a face 32.1 oriented towards the fiber preform 22 formed as the second face 20.2 of the panel 20 to be obtained.

The cladding 26 can comprise other elements such as a mold-stripping film or a draining system, for example. These elements are not described further because they are known to the person skilled in the art.

According to one configuration, the first die tool 24 comprises a system for draining air from the cladding 26 that makes it possible to reduce the pressure in the cladding 26, arranged at the periphery of the fiber preform 22, that is to say, on the cold technical area. That advantageously makes it possible to decouple the temperature and pressure cycles.

According to a feature of the invention, the first die tool 24 is produced in at least one material with low expansion coefficient to prevent it from deforming.

According to an embodiment visible in FIG. 8, the cladding 26 comprises an insulating cover 34 which covers the bladder 28 to limit the heat losses and conserve the heat between the first die tool 24 and the insulating cover 34. According to another embodiment, the cover 34 is thermally controlled and comprises at least one circuit in which circulates a heat-transfer fluid whose temperature is regulated.

According to a feature of the invention, the consolidation device is of inductive type and comprises an induction heating system 36 configured to generate at least one electromagnetic field in a heating zone 38 and at least one susceptor 40 incorporated in the first die tool 24 and/or the cladding 26, producing a heating, because of the appearance of eddy currents, when it is positioned in the electromagnetic field of the induction heating system 36.

The use of an induction heating system 36 makes it possible to obtain a greater thermal responsiveness and to reduce the temperature rise and fall times, which contributes to reducing the duration of the thermal cycles and to increasing production rates.

According to a particular feature, apart from the susceptors 40, the first die tool 24 and the cladding 26 are produced in materials that are transparent to the electromagnetic waves in order not to produce significant heating when they are positioned in an electromagnetic field.

According to one embodiment, the first die tool 24 comprises a rigid supporting structure 42, made of glass fiber and/or epoxy resin composite for example, having a recess 44 on a first face 42.1, oriented towards the fiber preform 22, and a mat 46, made of ceramic material for example, configured to be housed in the recess 44 and to which the fiber preform 22 is affixed. The mat 46 has a face 46.1 which forms, with the first face 42.1 of the supporting structure 42, the support surface 24.1.

According to a configuration visible in FIG. 7, the susceptors 40 are only incorporated in the first die tool 24, more particularly in its mat 46.

According to another configuration visible in FIG. 8, the susceptors 40 are incorporated in the cladding 26, more particularly in the forming plate 32, and in the first die tool 24, more particularly in its mat 46.

According to another configuration, the susceptors 40 are only incorporated in the cladding 26, more particularly in the forming plate 32.

Incorporating the susceptors 40 in the forming plate 32 and/or the mat 46 makes it possible to position them as close as possible to the fiber preform 22, which contributes to improving the efficiency of the heating.

The susceptors 40 comprise a plurality of discontinuous conductive elements in order to be able to adjust the surface density and/or the distribution of the susceptors 40 as a function of the characteristics sought for the heating. Thus, the surface density of the susceptors 40 can be high, in line with a zone of the fiber preform 22 requiring a significant input of heat, such as a thick zone of the fiber preform 22, for example. On the other hand, the surface density of the susceptors 40 can be low, in line with a zone of the fiber preform 22 requiring a low input of heat, such as a thinner zone of the fiber preform 22, for example.

Furthermore, with the generation of a uniform electromagnetic field, the eddy currents loop back locally into the discontinuous susceptors, which allows for uniform heating.

According to a configuration, the susceptors 40 are evenly distributed in the fiber preform 22, and notably in a zone of constant thickness of the fiber preform 22.

According to some configurations, some zones of the cladding 26 and/or of the first die tool 24 may possibly not have susceptors if these zones do not require heat input.

Thus, by adjusting the density and the distribution of the susceptors 40, it is possible to decorrelate the geometry of the fiber preform 22 and the heat input by concentrating the latter in the zones where it is necessary and by limiting it in the zones of the first die tool 24 and of the cladding 26 which do not need to be heated.

According to another feature, the induction heating system 36 is configured to generate an electromagnetic field with a low frequency lower than 50 kHz, preferably lying between 20 and 30 kHz. This feature makes it possible to avoid the appearance of eddy currents in the reinforcing fibers, for example made of carbon, of the fiber preform 22.

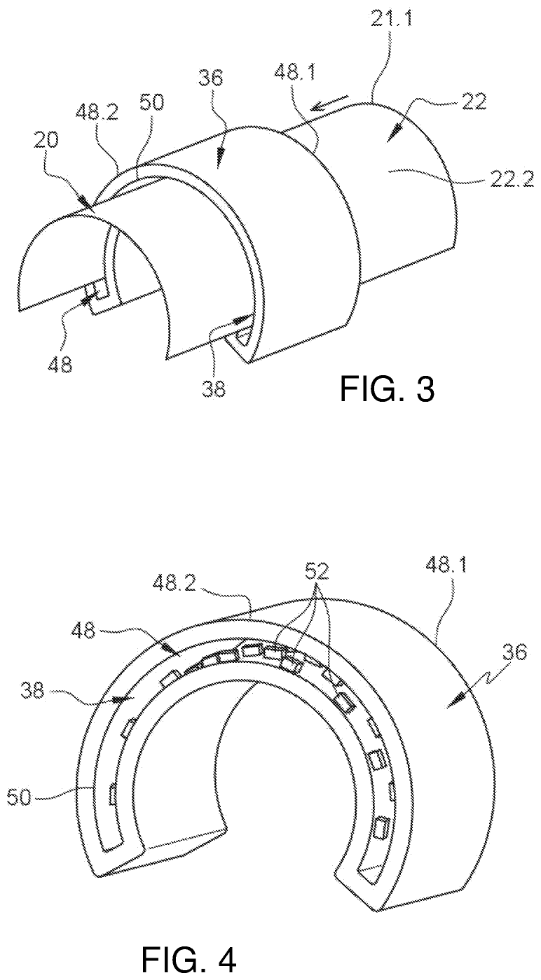

According to an embodiment visible in FIGS. 3, 4 and 7, the induction heating system 36 comprises a tunnel 48 configured to house, at least partially, the fiber preform 22, the first die tool 24 and the cladding 26.

The tunnel 48 extends in a first direction between first and second ends 48.1, 48.2 and has a constant flow cross-section 50 in transverse planes at right angles to the first direction, between the first and second ends 48.1, 48.2. When the fiber preform 22 is positioned at least partially in the induction heating system 36, the first direction of the tunnel 48 and the longitudinal direction of the fiber preform 22 are substantially parallel.

The flow cross-section 50 is configured in such a way that there remains a small space all around the maximum cross-section of the assembly formed by the fiber preform 22, the first die tool 24 and the cladding 26.

This arrangement makes it possible to bring the induction heating system 36 as close as possible to the susceptors 40.

According to one embodiment, the induction heating system comprises at least one solenoid having a winding section which follows the profile of the flow cross-section 50. This arrangement makes it possible to optimize the looping back of the induced currents.

According to another feature, the induction heating system 36 is dimensioned to generate a heating zone 38 covering a surface below that occupied by the fiber preform 22. In addition, the consolidation device comprises a mechanism configured to induce a relative movement between the induction heating system 36 and the first die tool 24 supporting the fiber preform 22 such that the fiber preform 22 crosses the heating zone 38 from its first end 21.1 to its second end 21.2. In other words, the consolidation device comprises a mechanism for displacing the induction heating system 36 and/or the first die tool 24 supporting the fiber preform 22 with respect to one another such that all the fiber preform 22 crosses the heating zone 38.

This arrangement makes it possible to be able to consolidate parts of large dimensions with an induction heating system of smaller dimensions, which limits the investment costs.

According to a first configuration, the first die tool 24 is fixed and the consolidation device comprises a displacement mechanism configured to translate the induction heating system 36 with respect to the first die tool 24 in the longitudinal direction DL.

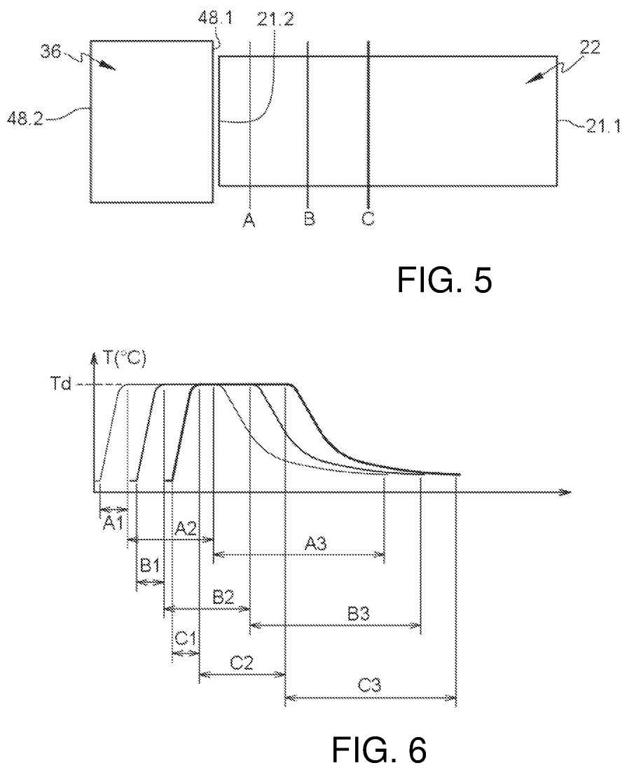

According to a second configuration visible in FIGS. 3 and 5, the induction heating system 36 is fixed and the consolidation device comprises a displacement mechanism configured to translate the first die tool 24 with respect to the induction heating system 36 in the longitudinal direction DL.

Thus, as soon as a first cross-section A of the fiber preform 22 enters into the induction heating system 36, that provokes a strong increase in the temperature over a short period A1 to reach a given temperature Td in the fiber preform 22 in line with the first cross-section A. This temperature Td is maintained for a certain period A2 until the first cross-section A exits from the induction heating system 36. Next, the temperature in the fiber preform 22 in line with the first cross-section A decreases for a period A3.

Next, as soon as a second cross-section B of the fiber preform 22 enters into the induction heating system 36, that provokes a strong increase in temperature over a short period B1 to reach the given temperature Td in the fiber preform 22 in line with the second cross-section B. This temperature Td is maintained for a certain period B2 until the second cross-section B exits from the induction heating system 36. Next, the temperature in the fiber preform 22 in line with the second cross-section B decreases for a period B3.

Finally, as soon as a third cross-section C of the fiber preform 22 enters into the induction heating system 36, that provokes a strong increase in the temperature over a short period C1 to reach the given temperature Td in the fiber preform 22 in line with the third cross-section C. This temperature Td is maintained for a certain period C2 until the third cross-section C exits from the induction heating system 36. Next, the temperature in the fiber preform 22 in line with the third cross-section C decreases for a period C3.

The parameters of the induction heating system 36, notably the relative speed between the induction heating system 36 and the first die tool 24 and the characteristics of the magnetic field generated, are adjusted so as to obtain a required temperature over a given period at each cross-section of the fiber preform 22 to obtain the transformation of the fiber preform 22 into a rigid panel 20 by consolidation. Thus, for each cross-section A, B, C, the temperature Td and the periods A2, B2, C2 are determined so as to obtain the transformation of the fiber preform 22 into a rigid panel 20 by consolidation.

The relative speed between the induction heating system 36 and the first die tool 24 can be constant or variable and regulated in order to adjust the heat input at each cross-section of the fiber preform 22.

According to an embodiment illustrated by FIG. 4, the induction heating system 36 comprises rolling or sliding seats 52 to promote the scrolling of the first die tool 24 with respect to the induction heating system 36, the first die tool 24 being in contact with the rolling or sliding seats 52.

According to one embodiment, the consolidation device can comprise at least one track upstream and/or downstream of the induction heating system 36 to support the first die tool 24 on either side of the induction heating system 36. The consolidation device can also comprise a cooling tunnel at the output of the induction heating system 36 to provoke a faster drop in temperature. At the output of the heating system 36, the panel 20 can also be cooled to ambient temperature.

The consolidation device also comprises a control for controlling, among other things, the induction heating system 36 and the relative speed between the fiber preform 22 and the induction heating system 36.

The induction consolidation device according to the invention makes it possible to obtain contactless heating with a high thermal responsiveness, to be able to decouple the temperature and pressure cycles and to improve energy efficiency.

When the induction heating system 36 and the fiber preform 22 are mobile with respect to one another, a dynamic heating mode is obtained which makes it possible to reduce the dimensions of the induction heating system 36 and, thereby, the investment cost.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A consolidation device for consolidating a fiber preform to obtain a panel made of composite material having a first face, a second face opposite the first face, and transverse sections linking the first and second faces, the panel extending in a longitudinal direction, the fiber preform comprising a first end and a second end opposite the first end in the longitudinal direction, the consolidation device comprising:
a first die tool which has a support surface, in contact with the fiber preform, shaped as the first face of the panel to be obtained,
a cladding configured to cover the fiber preform,
a heating system configured to heat the fiber preform,
the heating system being an induction heating system configured to generate at least one electromagnetic field in a heating zone,
the heating zone covering a surface lower than a surface occupied by the fiber preform,
susceptors, incorporated in at least one out of the first die tool and the cladding, producing a heating when they are positioned in the electromagnetic field generated by the induction heating system, and
a mechanism configured to induce a relative movement between the induction heating system and the first die tool supporting the fiber preform such that the fiber preform crosses the heating zone from the first end to the second end.

2. The consolidation device according to claim 1, wherein the cladding comprises a forming plate comprising a face oriented towards the fiber preform and shaped as the second face of the panel to be obtained, at least one susceptor being incorporated in the forming plate.

3. The consolidation device according to claim 1, wherein the susceptors comprise a plurality of discontinuous conductive elements.

4. The consolidation device according to claim 1, wherein the induction heating system comprises a tunnel which has a constant flow cross-section configured so that there remains a small space all around a maximum cross-section of an assembly formed by the fiber preform, the first die tool and the cladding.

5. The consolidation device according to claim 4, wherein the induction heating system comprises at least one solenoid having a winding section which follows a profile of the flow cross-section.

6. The consolidation device according to claim 5, wherein the induction heating system is fixed and wherein the consolidation device comprises a displacement mechanism configured to translate the first die tool with respect to the induction heating system in the longitudinal direction.

7. The consolidation device according to claim 6, wherein the induction heating system comprises rolling or sliding seats, the first die tool being in contact with said rolling or sliding seats.

8. The consolidation device according to claim 6, further comprising at least one track upstream or downstream of the induction heating system, the first die tool being supported by said track.

9. The consolidation device according to claim 1, wherein the first die tool is produced in at least one material with low expansion coefficient.

10. The consolidation device according to claim 9, wherein the first die tool comprises a rigid supporting structure having a recess on a first face oriented towards the fiber preform, and a mat configured to be housed in the recess and to which the fiber preform is affixed, at least one of the susceptors being incorporated in the mat.
